(19) United States
(12) Patent Application Publication
(10) Pub. No.: US 2025/0307737 A1
(43) Pub. Date: Oct. 2, 2025

(54) SYSTEM AND METHOD FOR COUNTER OFFERING SHIFT TRADES

(71) Applicant: NICE LTD., Ra'anana (IL)

(72) Inventors: Richa DEO, Jamshedpur (IN); Pratik GHOTEKAR, Pune (IN); Kanchan VASNANI, Indore (IN)

(21) Appl. No.: 18/619,899

(22) Filed: Mar. 28, 2024

(51) Int. Cl. G06Q 10/0631

(52) U.S. Cl. CPC G06Q 10/063116

(57) ABSTRACT

Systems adapted for counter offering shift trades and methods, and non-transitory computer readable media, include monitoring a shift schedule for a set of agents using certain parameters; identifying a shift trade request from a source agent; identifying a set of tradeable shifts for the source agent; sending the shift trade request and the set of tradeable shifts to a set of target agents; receiving a counter shift trade request from a target agent, wherein the counter shift trade request comprises a tradeable shift within the set of tradeable shifts selected by the target agent; sending the counter shift trade request to the source agent; and wherein when the source agent accepts the counter shift trade request, the shift schedule is updated based on the counter shift trade request; and sending a schedule notification to the source agent and to the target agent regarding the updated shift schedule.

### COPYRIGHT NOTICE

A portion of the disclosure of this patent document contains material which is subject to copyright protection. The copyright owner has no objection to the facsimile reproduction by anyone of the patent document or the patent disclosure, as it appears in the U.S. Patent and Trademark Office patent file or records, but otherwise reserves all copyright rights whatsoever.

### TECHNICAL FIELD

The present disclosure relates generally to methods and systems of counter shift trade request management, and more specifically relates to methods and systems for counter offering shift trades in a dynamic environment, based on changes in staffing requirements and/or according to shift trade approval criteria.

### BACKGROUND

The subject matter discussed in this background section should not be assumed to be prior art merely as a result of its mention herein. Similarly, a problem mentioned in this background section or associated with the subject matter of the background section should not be assumed to have been previously recognized (or be conventional or well-known) in the prior art. The subject matter in this background section merely represents different approaches, which in and of themselves may also be inventions.

Efficiency and adaptability in schedule change management is critical for any contact center organization. An important aspect of schedule change management includes attention to schedule change requests from employees (contact center agents); specifically, agent shift trade requests. Agents may wish to trade shifts for which they have initially been scheduled to work, for a shift that has been assigned to another agent. Such trades may be initiated by a source agent, who sends a shift trade request to a target agent. Currently, when such a shift trade request is made, a target agent may only have two options in response to the request: to either accept or decline the request. Since the target agent is unable to negotiate the request for an alternative shift, this process is inefficient and time-consuming, as the source agent has to continually re-initiate the shift trade request each time it is declined. A source agent may have to re-initiate the shift trade request several times with the same target agent or different target agents, in order to try making the shift exchange with different options of dates or times of scheduled shifts that are suitable to both the source and target agent.

There exist workforce management applications that offer the above-described shift trade feature, however, there are currently no options available which offer the possibility of a counter shift trade request. Such an option would enable a source and a target agent to more efficiently reach a mutually agreeable shift trade. Contact center supervisors and/or administrators may restrict which shifts are eligible for shift trading by requiring adherence to shift trade approval criteria.

Accordingly, what is needed is a system that can streamline the shift trade request process by enabling a target agent to offer a counter shift trade request to the source agent in a dynamic environment, based on changes in staffing requirements and/or according to shift trade approval criteria.

### BRIEF DESCRIPTION OF THE DRAWINGS

The present disclosure is best understood from the following detailed description when read with the accompanying figures. It is emphasized that, in accordance with the standard practice in the industry, various features are not drawn to scale. In fact, the dimensions of the various features may be arbitrarily increased or reduced for clarity of discussion. In the figures, elements having the same designations have the same or similar functions.

FIG. 1 is a simplified data flow in a system according to various aspects of the present disclosure.

FIG. 2 is a flowchart of a method of counter shift trade request management according to embodiments of the present disclosure.

FIG. 3 illustrates an exemplary graphical user interface through which a target agent may receive a shift trade request from the agent shift schedule manager, according to embodiments of the present disclosure.

FIG. 4 illustrates an exemplary graphical user interface through which a target agent may submit a counter shift trade request, according to embodiments of the present disclosure.

FIG. 5 illustrates an exemplary graphical user interface through which a source agent may accept a counter shift trade request, according to embodiments of the present disclosure.

FIG. 6 is a block diagram of a computer system suitable for implementing one or more components in FIG. 1 according to one embodiment of the present disclosure.

### DETAILED DESCRIPTION

This description and the accompanying drawings that illustrate aspects, embodiments, implementations, or applications should not be taken as limiting—the claims define the protected invention. Various mechanical, compositional, structural, electrical, and operational changes may be made without departing from the spirit and scope of this description and the claims. In some instances, well-known circuits, structures, or techniques have not been shown or described in detail as these are known to one of ordinary skill in the art.

In this description, specific details are set forth describing some embodiments consistent with the present disclosure. Numerous specific details are set forth in order to provide a thorough understanding of the embodiments. It will be apparent, however, to one of ordinary skill in the art that some embodiments may be practiced without some or all of these specific details. The specific embodiments disclosed herein are meant to be illustrative but not limiting. One of ordinary skill in the art may realize other elements that, although not specifically described here, are within the scope and the spirit of this disclosure. In addition, to avoid unnecessary repetition, one or more features shown and described in association with one embodiment may be incorporated into other embodiments unless specifically described otherwise or if the one or more features would make an embodiment non-functional.

The systems and methods described herein relate to counter shift trade request management. In various embodiments, a shift schedule for a set of agents is monitored using parameters affecting staffing needs and shift trade approval criteria. Shift trade requests and counter shift trade requests are submitted by an agent through a graphical user interface. A shift trade request from a source agent is identified. A set of tradeable shifts for the source agent is identified. The shift trade request and the set of tradeable shifts are sent to a set of target agents. The shift trade request and the set of tradable shifts are displayed through the graphical user interface. A counter shift trade request from a target agent from the set of target agents is received. The counter shift trade request comprises a tradeable shift within the set of tradeable shifts selected by the target agent. The counter shift trade request is sent to the source agent; the counter shift trade request is displayed through the graphical user interface. When the source agent accepts the counter shift trade request, the shift schedule is updated based on the counter shift trade request. A schedule notification is sent to the source agent and to the target agent regarding the updated shift schedule. In some embodiments, the schedule notification may be sent to the supervisor of the contact center agent.

In various embodiments, parameters that are monitored may include one or more of unplanned absenteeism, contact volume inflow, shift characteristics, skills needed, understaffing, overstaffing, or any combination thereof. In certain embodiments, parameters are determined by a contact center supervisor or administrator.

In several embodiments, the shift trade request from the source agent may be a request to exchange a full shift assigned to the source agent, or a portion of a full shift assigned to the source agent.

In certain embodiments, the set of tradeable shifts for the source agent are identified using the parameters affecting staffing needs and shift trade approval criteria.

In various embodiments, when a counter shift trade request from a target agent is not received or when the source agent does not accept a counter shift trade request from a target agent, the operations further comprise closing the shift trade request.

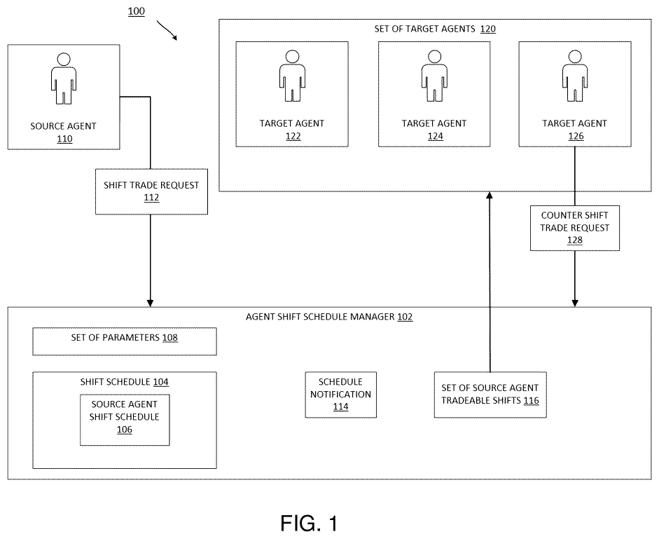

FIG. 1 illustrates data flow in an example counter shift trade request management system 100 according to some embodiments of the present disclosure. As shown, counter shift trade request management system 100 may include or implement a plurality of devices, servers, and/or software components that operate to perform various methodologies in accordance with the described embodiments. Exemplary devices and servers may include device, stand-alone, and enterprise-class servers, operating an operating system (OS) such as a MICROSOFT® OS, a UNIX® OS, a LINUX® OS, or another suitable device and/or server-based OS. It will be appreciated that the devices and/or servers illustrated in FIG. 1 may be deployed in other ways and that the operations performed, and/or the services provided, by such devices and/or servers may be combined or separated for a given embodiment and may be performed by a greater number or fewer number of devices and/or servers. For example, machine learning (ML), neural network (NN), and other artificial intelligence (AI) architectures have been developed to improve predictive analysis and classifications by systems in a manner similar to human decision-making, which increases efficiency and speed in performing predictive analysis of transaction data sets. One or more devices and/or servers may be operated and/or maintained by the same or different entities.

As shown, data in counter shift trade request management system 100 includes shift schedule 104, source agent shift schedule 106, shift trade request 112, schedule notification 114, set of source agent tradeable shifts 116, and counter shift trade request 128.

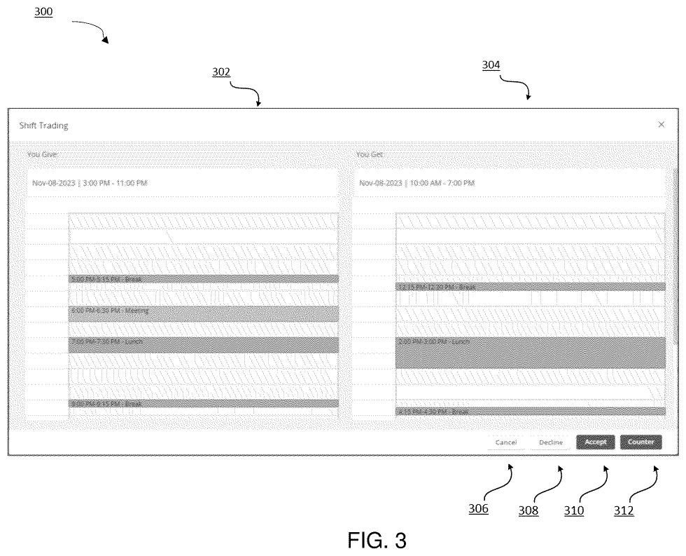

In one or more embodiments, a contact center shift schedule is a dynamic environment, with shift interval staffing fluctuating in real-time as staffing need may increase or decrease, and as contact center agents request schedule changes, such as, for example without limitation, trading shifts with other agents, requesting time off, requesting additional shifts, etc. Contact center agents may request such schedule changes through a graphical user interface. Examples of such a graphical user interface are discussed below with respect to FIGS. 3-5.

At any given time, agent shift schedule manager 102 may receive one or more shift trade request(s) 112 (also referred to as shift trade request 112) submitted by one or more contact center agents. A contact center agent that has submitted a shift trade request may be referred to as a source agent (e.g., source agent 110). A shift trade request 112 may be a request to exchange a shift for which the source agent is currently scheduled to work, with a shift of another, unspecified contact center agent (also referred to as a target agent).

In one or more embodiments, shift trade request(s) 112 may correspond with a time-based shift interval for which the source agent, for example without limitation, is scheduled to work, wishes to exchange with another agent, wishes to request time off, will not be able to work, or wishes to work. A source agent may submit a shift trade request 112 to request an exchange of a full shift assigned to the source agent, or to request an exchange of a portion of a full shift assigned to the source agent.

According to various embodiments, counter shift trade request management system 100 may include agent shift schedule manager 102. Agent shift schedule manager 102 may be responsible for monitoring contact center shift schedule 104 (also referred to as shift schedule 104), which includes shift scheduling information for a set of contact center agents (e.g., source agent shift schedule 106).

Agent shift schedule manager 102 may use a set of parameters 108 to assess whether a shift for which a shift trade request 112 has been submitted by a source agent is eligible for shift trading. Set of parameters 108 may include, for example, parameters affecting staffing needs and/or shift trade approval criteria set by contact center supervisors or administrators. In one or more embodiments, set of parameters 108 may include one or more of unplanned absenteeism, contact volume inflow, shift characteristics, skills needed, understaffing, overstaffing, or any combination thereof. For example, a shift may need to be staffed by a contact center agent with a specific skill set in order to perform the work scheduled in that shift, a shift may require a specific agent to meet with a supervisor, etc. In some embodiments, monitoring operational parameters 108 may require, for example but without limitation to, monitoring the rate of incoming contacts to the contact center, tracking the absence of agents for shift times due to unforeseen circumstances, monitoring seasonal variations or special events such as local health issues and holidays, and/or other relevant factors that impact workforce requirements. Set of parameters 108 may be requested or set by a contact center supervisor or administrator.

If a shift trade request 112 submitted by a source agent does not meet the set of parameters 108, agent shift schedule manager 102 will close the shift trade request. Agent shift schedule manager 102 may also send a schedule notification 114 to the source agent informing him/her that their shift trade request 112 has been denied. In one or more embodiments, schedule notification 114 may be sent via web, mobile, and/or email notification. In some embodiments, schedule notification 114 may also be sent to one or more contact center supervisors and/or administrators. In some embodiments, the source agent may then submit or be requested to submit a revised shift trade request 112.

In one or more embodiments, if a shift trade request 112 submitted by a source agent meets the set of parameters 108, agent shift schedule manager 102 may identify a set of source agent tradeable shifts 116. For example, if source agent 110 submits a shift trade request 112, and shift trade request 112 meets set of parameters 108, agent shift schedule manager 102 will identify a set of source agent tradeable shifts 116 using the source agent shift schedule 106 of source agent 110.

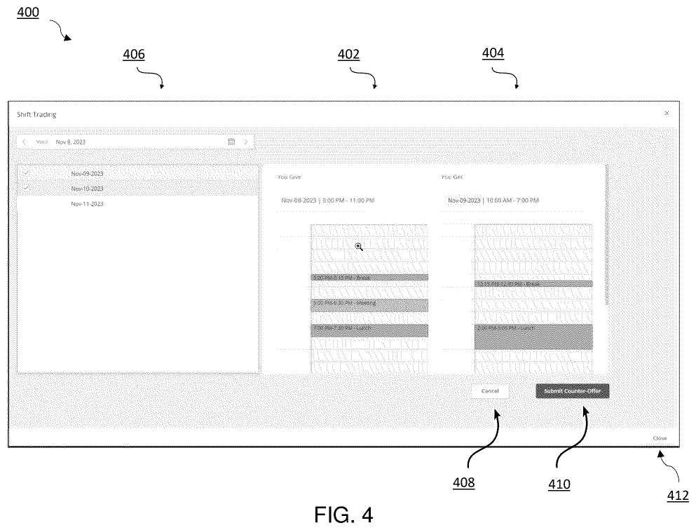

Set of source agent tradeable shifts 116 includes only shifts currently assigned to the source agent in shift schedule 104 (e.g., source agent shift schedule 106) that meet set of parameters 108. Agent shift schedule manager 102 then sends the shift trade request 112 from the source agent as well as the set of source agent tradeable shifts 116 to a set of target agents (e.g., set of target agents 120). The set of target agents may include contact center agents other than the source agent (e.g., target agents 122, 124, and 126). The shift trade request 112 from the source agent as well as the set of source agent tradeable shifts 116 may be displayed to each target agent of the set of target agents through a graphical user interface, which is discussed further below in relation to FIGS. 3 and 4.

In some embodiments, agent shift schedule manager 102 may then receive a counter shift trade request 128 from a target agent of the set of target agents (e.g., from target agent 126 of set of target agents 120). Counter shift trade request 128 may include a tradeable shift of the set of source agent tradeable shifts 116 that has been selected by the target agent (e.g., by target agent 126), as an alternative source agent shift for which the target agent will trade one of their currently assigned shifts. In some embodiments, counter shift trade request 128 may include more than one tradeable shift of the set of source agent tradeable shifts 116 if the target agent is flexible in terms of the source agent tradeable shift they are willing to trade for.

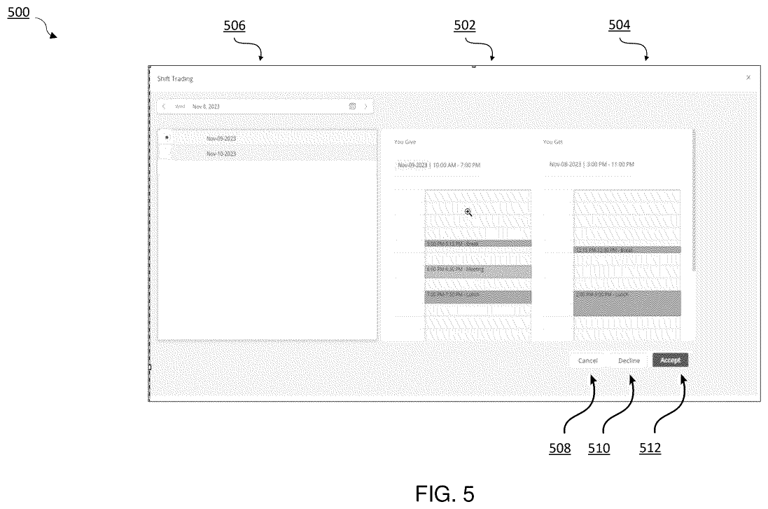

Agent shift schedule manager 102 then sends the counter shift trade request 128 to the source agent (e.g., source agent 110), which may be displayed through a graphical user interface, discussed further below in relation to FIG. 5. If the source agent accepts a source agent tradeable shift offered through the counter shift trade request 128, agent shift schedule manager 102 closes shift trade request 112 and counter shift trade request 128. Agent shift schedule manager 102 also updates shift schedule 104 according to the source agent and target agent shifts negotiated in counter shift trade request 128 and sends a schedule notification 114 to the source agent (e.g., source agent 110) and the target agent that submitted the counter shift trade request (e.g., target agent 126). In one or more embodiments, schedule notification 114 may be sent via web, mobile, and/or email notification. In some embodiments, schedule notification 114 may also be sent to one or more contact center supervisors and/or administrators.

In other embodiments, agent shift schedule manager 102 may not receive a counter shift trade request 128 from the set of target agents. In such cases, agent shift schedule manager 102 will close the shift trade request, and send the source agent a schedule notification 114 informing him/her that their shift trade request 112 has been denied. Alternatively, the agent shift schedule manager 102 may hold the shift trade request, notify the source agent that the shift trade request 112 is pending, and schedule a further determination after delaying a suitable period (e.g., a shift change, a day, a week, a biweek, etc.) to evaluate, e.g., if staffing needs decrease during the requested shift trade request 112 or if a second shift trade request or a counter shift trade request 128 are provided.

In still other embodiments, a target agent of set of target agents 120 may approve the shift trade request 112 submitted by source agent as-is. In such cases, agent shift schedule manager 102 closes shift trade request 112. Agent shift schedule manager 102 also updates shift schedule 104 and sends a schedule notification 114 to the source agent and target agent that accepted the shift trade request. In one or more embodiments, schedule notification 114 may be sent via web, mobile, email notification, or a combination thereof. In some embodiments, schedule notification 114 may also be sent to one or more contact center supervisors and/or administrators.

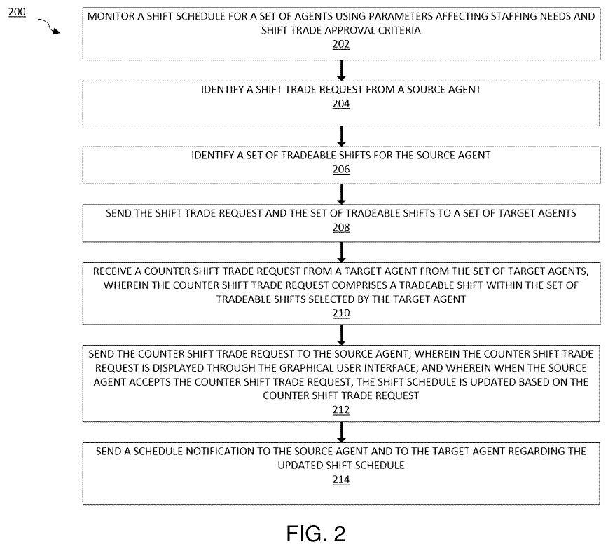

FIG. 2 is an exemplary flowchart 200 for counter shift trade management according to embodiments of the present disclosure. Note that one or more steps, processes, and methods described herein of flowchart 200 may be omitted, performed in a different sequence, or combined as desired or appropriate based on the guidance provided herein. Flowchart 200 of FIG. 2 includes operations for schedule change management, as discussed in reference to FIG. 1. One or more of steps 202-210 of flowchart 200 may be implemented, at least in part, in the form of executable code stored on non-transitory, tangible, machine-readable media that when run by one or more processors may cause the one or more processors to perform one or more of steps 202-210. In some embodiments, flowchart 200 can be performed by one or more computing devices discussed in schedule management system 100 of FIG. 1.

Accordingly, at step 202 of flowchart 200, counter shift trade management system 100, through agent shift schedule manager 102, monitors shift schedule 104 for a set of contact center agents using set of parameters 108 affecting staffing needs and shift trade approval criteria. In one or more embodiments, set of parameters 108 may include, but are not limited to, one or more of unplanned absenteeism, contact volume inflow, shift characteristics, skills needed, understaffing, overstaffing, or any combination thereof. Set of parameters 108 may be requested or set by a contact center supervisor or administrator.

At step 204 of flowchart 200, agent shift schedule manager 102 identifies a shift trade request 112 received from a source agent 110. A shift trade request 112 may be a request to exchange a shift for which the source agent is currently scheduled to work, with a shift of another, unspecified contact center agent (also referred to as a target agent).

In one or more embodiments, shift trade request(s) 112 may correspond with a time-based shift interval for which the source agent, for example without limitations, is scheduled to work, wishes to exchange with another agent, wishes to request time off, will not be able to work, or wishes to work. A source agent 110 may submit a shift trade request 112 to request an exchange of a full shift assigned to the source agent, or to request an exchange of a portion of a full shift assigned to the source agent.

At step 206, agent shift schedule manager 102 identifies a set of source agent tradeable shifts 116 (e.g., a set of tradeable shifts for source agent 110), using the source agent shift schedule 106 for source agent 110. Set of source agent tradeable shifts 116 includes only shifts currently assigned to the source agent in shift schedule 104 (e.g., source agent shift schedule 106) that meet set of parameters 108.

At step 208 of flowchart 200, agent shift schedule manager 102 sends the shift trade request 112 and set of source agent tradeable shifts 116 to set of target agents 120. Set of target agents 120 may include one or more target agents (e.g., target agents 122, 124, and 126) other than the source agent (e.g., source agent 110).

At step 210 of flowchart 200, agent shift schedule manager 102 receives a counter shift trade request 128 from a target agent (e.g., target agent 126) from the set of target agents 120. Counter shift trade request 128 includes at least one source agent tradeable shift of set of source agent tradeable shifts 116 that has been selected by the target agent (e.g., target agent 126), as an alternative source agent shift for which the target agent will trade one of their currently assigned shifts. Counter shift trade request 128 may include one or more source agent tradeable shifts of set of source agent tradeable shifts 116 selected by the target agent.

At step 212 of flowchart 200, agent shift schedule manager 102 sends the counter shift trade request 128 to the source agent 110. When the source agent 110 accepts one of the source agent tradeable shifts 116 offered by target agent 126 in the counter shift trade request 128, the shift schedule 104 is updated based on the exchange of source agent 110 and target agent 126 shifts as negotiated in counter shift trade request 128.

Accordingly, at step 214 of flowchart 200, agent shift schedule manager 102 sends a schedule notification 114 to source agent 110 and the target agent (e.g., target agent 126) regarding the updated shift schedule 104. In one or more embodiments, schedule notification 114 may be sent via web, mobile, and/or email notification. In some embodiments, schedule notification 114 may also be sent to one or more contact center supervisors and/or administrators.

FIG. 3 is an exemplary graphical user interface 300 through which a target agent of a set of target agents may receive a shift trade request from the agent shift schedule manager 102. The target agent may be, for example, one of set of target agents 120 with respect to FIG. 1. The shift trade request may be, for example, shift trade request 112 with respect to FIG. 1. The interface 300 allows the target agent to assess the shift trade request visually by displaying both the shift that the target agent is currently assigned to work (and would be trading away to the source agent) and the shift that the target agent would be assigned to work if they accept the shift trade request (i.e., the shift currently assigned to the source agent that the source agent wishes to exchange). For example, section 302 of interface 300, which may be titled “You Give”, displays the target agent's currently assigned shift that they would be trading away if the shift trade request is accepted. Section 304 of interface 300, which may be titled “You Get”, displays the source agent's shift that the target agent would be assigned to if the shift trade request is accepted.

The interface 300 may include various action options that the target agent may select in order to respond to the shift trade request. For example, action options (also referred to as “option”) 306, 308, 310, and 312 each correspond to a response the target agent may submit through the interface 300 and/or to the agent shift schedule manager 102 in response to a shift trade request.

Option 306 allows a target agent to ‘cancel’ viewing interface 300 showing the shift trade request. This option allows the target agent to view the shift trade request later. Option 308 allows a target agent to ‘decline’ the shift trade request. If option 308 is selected by a target agent, the agent shift schedule manager 102 removes the shift trade request for that target agent, and the shift trade request will no longer be displayed through interface 300 to that target agent. If option 308 is selected by all target agents of the set of target agents that receive the shift trade request, the agent shift schedule manager 102 closes the shift trade request and sends a schedule notification to the source agent that submitted the shift trade request to inform him/her that their shift trade request has been declined.

Option 310 allows a target agent to ‘accept’ the shift trade request. If option 310 is selected by a target agent, the agent shift schedule manager 102 updates the shift schedule with respect to the shift trade request, and removes the shift trade request for the other target agents of the set of target agents. The agent shift schedule manager 102 will then send a schedule notification to the source agent and the target agent that accepted the shift trade request.

Option 312 allows a target agent to ‘counter’ the shift trade request. If option 312 is selected by a target agent, the target agent is able to submit a counter shift trade offer. The interface through which the target agent is able to submit a counter shift trade offer is discussed in detail with respect to FIG. 4.

FIG. 4 is an exemplary graphical user interface 400 through which a target agent may submit a counter shift trade request, e.g., counter shift trade request 128 submitted by target agent 126, with respect to FIG. 1. The interface 400 allows the target agent to assess the shift trade request visually by displaying both the shift that the target agent is currently assigned to work (and would be trading away to the source agent) and the shift that the target agent would be assigned to work if they submit the counter shift trade request (i.e., the tradeable shift currently assigned to the source agent). For example, section 402 of interface 400, which may be titled “You Give”, displays the target agent's currently assigned shift that they would be trading away if the counter shift trade request is accepted. Section 404 of interface 400, which may be titled “You Get”, displays the source agent's shift that the target agent would be assigned to if the counter shift trade request is accepted.

Interface 400 includes section 406, which shows the target agent the set of source agent tradeable shifts available for the target agent to submit as a counter shift trade request. The set of source agent tradeable shifts (e.g., set of source agent tradeable shifts 116 in FIG. 1) includes only those shifts currently assigned to the source agent in the shift schedule (e.g., source agent shift schedule 106) that meet the shift trade eligibility criteria (e.g., set of parameters 108). Section 404 of interface 400 may be updated as the target agent selects various shifts in section 406 for viewing.

The interface 400 may include various action options that the target agent may select in order to respond to the shift trade request. For example, action options (also referred to as “option”) 408, 410, and 412 each correspond to a response the target agent may submit through the interface 400 and/or to the agent shift schedule manager 102 in response to a shift trade request.

Option 408 allows a target agent to ‘cancel’ viewing interface 400 showing the shift trade request and counter shift trade request choices. This option allows the target agent to view interface 400 later.

Option 410 allows a target agent to submit a counter shift trade request to the agent shift schedule manager 102. A target agent may select one or more source agent tradeable shifts to submit as the counter shift trade request. The counter shift trade request corresponds to the source agent tradeable shift(s) of the set of source agent tradeable shifts selected by the target agent in section 406, and the target agent's currently assigned shift in section 402. Once the target agent submits the counter shift trade request (e.g., ‘submit[s] counter offer’), the agent shift schedule manager 102 receives the counter shift trade request to pass along to the source agent. Option 412 allows the target agent to ‘close’ interface 400 once option 410 has been selected.

FIG. 5 is an exemplary graphical user interface 500 through which a source agent may accept a counter shift trade request (e.g., counter shift trade request 128 with respect to FIG. 1). The interface 500 allows the source agent to assess the counter shift trade request visually by displaying both the shift that the source agent is currently assigned to work (and would be trading away to the target agent) and the shift that the source agent would be assigned to work if they accept the counter shift trade request (i.e., the shift for which the source agent submitted the shift trade request, and that is currently assigned to the target agent). For example, section 502 of interface 500, which may be titled “You Give”, displays the source agent's currently assigned shift that they would be trading away if they accept the counter shift trade request. Section 504 of interface 500, which may be titled “You Get”, displays the target agent's shift that the source agent would be assigned to if they accept the counter shift trade request.

Interface 500 includes section 506, which displays the set of source agent tradeable shifts that the target agent has submitted in the counter shift trade request. Section 504 of interface 500 may be updated as the source agent selects various shifts in section 506 for viewing.

The interface 500 may include various action options that the target agent may select in order to respond to the shift trade request. For example, action options (also referred to as “option”) 508, 510, and 512 each correspond to a response the source agent may submit through the interface 500 and/or to the agent shift schedule manager 102 in response to a counter shift trade request.

Option 508 allows a source agent to ‘cancel’ viewing interface 500 showing the counter shift trade request and counter shift trade request shift choices. This option allows the target agent to view interface 400 later.

Option 510 allows a source agent to ‘decline’ the counter shift trade request. If option 510 is selected by a source agent, the agent shift schedule manager 102 removes the counter shift trade request for source agent, and the counter shift trade request will no longer be displayed through interface 500 to source agent. If option 510 is selected by the source agent for all counter shift trade requests received from the set of target agents, the agent shift schedule manager 102 closes the shift trade request and sends a schedule notification to the source agent that submitted the shift trade request to inform him/her that their shift trade request has been declined.

Option 512 allows a source agent to ‘accept’ the counter shift trade request by selecting one of the source agent tradeable dates submitted by the target agent. If option 512 is selected by a source agent, the agent shift schedule manager 102 updates the shift schedule with respect to the source agent tradeable date from the counter shift trade request selected by the source agent, and removes the shift trade request for the other target agents of the set of target agents. The agent shift schedule manager 102 will then send a schedule notification to the source agent and the target agent that submitted the counter shift trade request.

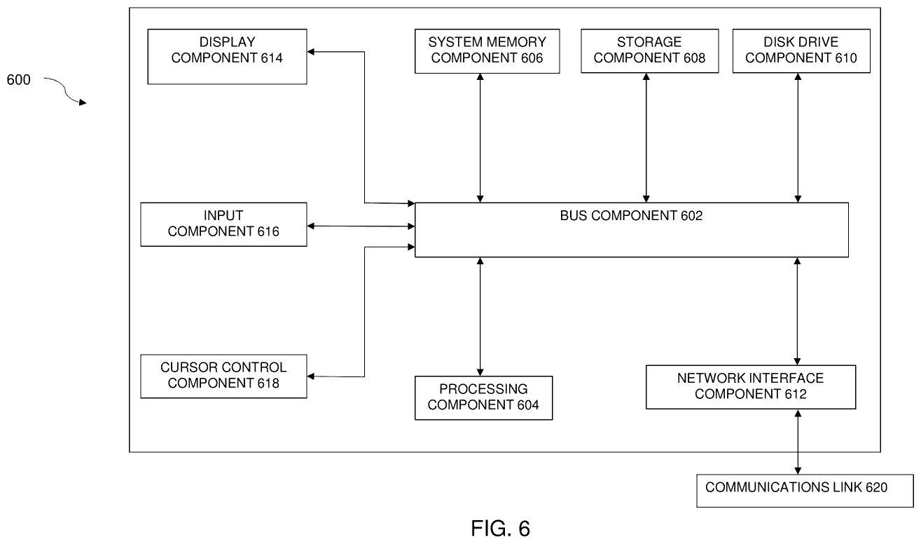

Referring now to FIG. 6, illustrated is a block diagram of a system 600 suitable for implementing embodiments of the present disclosure. System 600, such as part of a computer and/or a network server, includes a bus 602 or other communication mechanism for communicating information, which interconnects subsystems and components, including one or more of a processing component 604 (e.g., processor, micro-controller, digital signal processor (DSP), etc.), a system memory component 606 (e.g., RAM), a static storage component 608 (e.g., ROM), a network interface component 612, a display component 614 (or alternatively, an interface to an external display), an input component 616 (e.g., keypad or keyboard), and a cursor control component 618 (e.g., a mouse pad).

In accordance with embodiments of the present disclosure, system 600 performs specific operations by processor 604 executing one or more sequences of one or more instructions contained in system memory component 606. Such instructions may be read into system memory component 606 from another computer readable medium, such as static storage component 608. These may include instructions to monitor a shift schedule for a set of agents using parameters affecting staffing needs and shift trade approval criteria, wherein shift trade requests and counter shift trade requests are submitted by an agent through a graphical user interface, identify a shift trade request from a source agent, identify a set of tradeable shifts for the source agent, send the shift trade request and the set of tradeable shifts to a set of target agents, wherein the shift trade request and the set of tradeable shifts are displayed through the graphical user interface, receive a counter shift trade request from a target agent from the set of target agents, wherein the counter shift trade request comprises a tradeable shift within the set of tradeable shifts selected by the target agent, send the counter shift trade request to the source agent, wherein the counter shift trade request is displayed through the graphical user interface; and wherein when the source agent accepts the counter shift trade request, the shift schedule is updated based on the counter shift trade request, and send a schedule notification to the source agent and to the target agent regarding the updated shift schedule. In other embodiments, hard-wired circuitry may be used in place of or in combination with software instructions for implementation of one or more embodiments of the disclosure.

Logic may be encoded in a computer readable medium, which may refer to any medium that participates in providing instructions to processor 604 for execution. Such a medium may take many forms, including but not limited to, non-volatile media, volatile media, and transmission media. In various implementations, volatile media includes dynamic memory, such as system memory component 606, and transmission media includes coaxial cables, copper wire, and fiber optics, including wires that comprise bus 602. Memory may be used to store visual representations of the different options for searching or auto-synchronizing. In one example, transmission media may take the form of acoustic or light waves, such as those generated during radio wave and infrared data communications. Some common forms of computer readable media include, for example, RAM, PROM, EPROM, FLASH-EPROM, any other memory chip or cartridge, carrier wave, or any other medium from which a computer is adapted to read.

In various embodiments of the disclosure, execution of instruction sequences to practice the disclosure may be performed by system 600. In various other embodiments, a plurality of systems 600 coupled by communication link 620 (e.g., LAN, WLAN, PTSN, or various other wired or wireless networks) may perform instruction sequences to practice the disclosure in coordination with one another. Computer system 600 may transmit and receive messages, data, information and instructions, including one or more programs (i.e., application code) through communication link 620 and communication interface 612. Received program code may be executed by processor 604 as received and/or stored in disk drive component 610 or some other non-volatile storage component for execution.

Below are examples of full data structures usable with the present disclosure.
1. Data structure to send alternate dates of a source agent that are available for trade (e.g., set of source agent tradeable shifts 116, with respect to FIG. 1):
   {
      “partial”: false,
      “requestFromRequestor”: {
         “userId”: “11ed3b0c-8f6c-7710-9090-0242ac110003”,
         “requestedDateTime”: {
         “start”: “2024-02-10T13:00:00Z”,
         “end”: “2024-02-10T22:00:00Z”
         }
      },
   “counterTradeAlternateDays”: [
      {
      “availableForTrade”:
      {
      “start”: “2024-02-12T13:00:00Z”,
      “end”: “2024-02-12T22:00:00Z”
      },
      “start”: “2024-02-15T13:00:00Z”,
      “end”: “2023-02-15T22:00:00Z”
      },
      “start”: “2024-02-17T13:00:00Z”,
      “end”: “2024-02-17T22:00:00Z”
      }
   ]
   }
2. Data structure for trade request received by the set of target agents:
   run(pendingRequests):
      {
         “requestId”: “11eec656-767d-ff40-855d-0242ac110002”,
         “requestFromRequestor”: {
         “user”: {
         “userId”: “11ed3b0c-8f6c-7710-9090-0242ac110003”,
         “fullName”: “Richa Deo”,
         “userName”: “rdeo@nice.com”
         },
         “requestedDateTime”: {
         “zoneDate”: “2024-02-10”,
         “utcStartTime”: “2024-02-10T13:00:00”,
         “utcEndTime”: “2024-02-10T22:00:00”,
         “start”: “2024-02-10T13:00:00Z”,
         “end”: “2024-02-10T22:00:00Z”
         },
         “userId”: “11ed3b0c-8f6c-7710-9090-0242ac110003”
      },
      “requestToRequestee”: {
         “user”: {
         “userId”: “11edbd61-1c87-c290-9d71-0242ac110005”,
         “fullName”: “Sujata Agent”,
         “userName”: “sujataagent1 @nice.com”
         },
         “requestedDateTime”: {
         “zoneDate”: “2024-02-10”,
         “utcStartTime”: “2024-02-10T13:00:00”,
         “utcEndTime”: “2024-02-10T22:00:00”,
         “start”: “2024-02-10T13:00:00Z”,
         “end”: “2024-02-10T22:00:00Z”
         },
         “userId”: “11edbd61-1c87-c290-9d71-0242ac110005”
         },
         “status”: “CREATED”,
         “tradeType”: “PARTIAL_SHIFT”,
         “createdTime”: “2024-02-08T07:48:35Z”,
         “lastUpdatedBy”: “Richa Deo”,
      “counterTradeAlternateDays”: [
         {
      “availableForTrade”:
         {
         “start”: “2024-02-12T13:00:00Z”,
         “end”: “2024-02-12T22:00:00Z”
         },
         “start”: “2024-02-15T13:00:00Z”,
         “end”: “2023-02-15T22:00:00Z”
         },
         “start”: “2024-02-17T13:00:00Z”,
         “end”: “2024-02-17T22:00:00Z”
         }
   ]
      “schedules”: {
         “2024-02-10”: [{
         “shifts”: [{
         “id”: “11eeb6ae-31a3-d7f0-88c1-0242ac110003”,
         “shiftNotes”: null,
         “activityIntervals”: [ ],
         “baseActivityCodeId”: “ac39038b-f4dc-1100-0000-000000000000”,
         “lastModifiedTime”: “2024-01-19T09:36:16Z”,
         “start”: “2024-02-08T00:30:00Z”,
         “end”: “2024-02-08T09:30:00Z”
         }],
         “activityIntervals”: [ ],
         “userId”: “11ecba3e-2c2f-edc0-abb3-0242ac110002”,
         “workDurationMillis”: 0
         }, {
         “shifts”: [{
         “id”: “11eeb6ae-3139-a46d-88c1-0242ac110003”,
         “shiftNotes”: null,
         “activityIntervals”: [ ],
         “baseActivityCodeId”: “ac39038b-f4dc-1100-0000-000000000000”,
         “lastModifiedTime”: “2024-01-19T09:36:16Z”,
         “start”: “2024-02-08T00:30:00Z”,
         “end”: “2024-02-08T09:30:00Z”
         }],
         “activityIntervals”: [ ],
         “userId”: “11edbd61-1c87-c290-9d71-0242ac110005”,
         “workDurationMillis”: 0
         }]
      }
      “masterData”: {
         “scheduleUsers”: [{
         “id”: “11ecba3e-2c2f-edc0-abb3-0242ac110002”,
         “firstName”: “Richa”,
         “lastName”: “Deo”,
         “employeeGroupId”: “11ebf4dc-a954-51b0-9alf-0242ac110005”
         }, {
         “id”: “11edbd61-1c87-c290-9d71-0242ac110005”,
         “firstName”: “Sujata”,
         “lastName”: “Agent”,
         “employeeGroupId”: “11ebf4dc-a954-51b0-9alf-0242ac110005”
         }],
         “activityCodes”: [{
         “id”: “ac39038b-f4dc-1100-0000-000000000000”,
         “title”: “Open (Default)”,
         “priority”: 10,
         “open”: true,
         “work”: true,
         “overTime”: false,
         “defaultBaseCodeFlag”: true,
         “baseCodeFlag”: true,
         “deleteFlag”: false,
         “defaultLength”: 15,
         “createdBy”: “User”,
         “lastModified”: “2024-02-07T13:08:07Z”,
         “activityCodeCategory”: {
         “id”: “ac2c4342-f4dc-1100-0000-000000000000”,
         “title”: “Open”,
         “color”: “#E0EBF5”,
         “createdBy”: “User”,
         “lastModified”: “2021-08-04T04:30:18Z”
         },
         “silenceFlag”: false,
         “adherenceCategory”: null,
         “tradable”: true
         }]
      },
      “messages”: [ ]
   }
3. Data structure for a source agent accepting a counter trade shift request:
   {
      “agentConfig”: null,
      “scheduleTrades”: {
         “scheduleTrades”: [{
         “requestor”: {
         “userId”: “11ecba3e-2c2f-edc0-abb3-0242ac110002”,
         “fullName”: “Richa Deo”,
         “userName”: “rdeo@nice.com”
         },
         “requestee”: {
         “userId”: “11edbd61-1c87-c290-9d71-0242ac110005”,
         “fullName”: “Sujata Agent”,
         “userName”: “sujataagent1 @nice.com”
         },
         “requestId”: “11eec658-6685-2e90-a3af-0242ac110006”,
         “requestedDate”: “2024-02-15”,
         “status”: “ACCEPTED_BY_REQUESTEE”,
         “createdTime”: “2024-02-08T08:02:27Z”,
         “lastUpdatedBy”: “Sujata Agent”,
         “auditLog”: “status: CREATED, timestamp: 2024-02-08T08:02:27.449111200Z, by: Richa Deo\r\nstatus:
         ACCEPTED_BY_REQUESTEE, timestamp: 2024-02-08T08:02:42.289108520Z, by: Sujata Agent\r\n”,
         “startTime”: “2024-02-15T13:00:00Z”,
         “endTime”: “2024-02-15T22:00:00Z”
         }, {
         “requestor”: {
         “userId”: “11ecba3e-2c2f-edc0-abb3-0242ac110002”,
         “fullName”: “Richa Deo”,
         “userName”: “rdeo@nice.com”
         },
         “requestee”: {
         “userId”: “11edbd61-1c87-c290-9d71-0242ac110005”,
         “fullName”: “Sujata Agent”,
         “userName”: “sujataagent1 @nice.com”
         },
         “requestId”: “11eec656-767d-ff40-855d-0242ac110002”,
         “requestedDate”: “2024-02-08”,
         “status”: “CREATED”,
         “createdTime”: “2024-02-08T07:48:35Z”,
         “lastUpdatedBy”: “Richa Deo”,
         “auditLog”: “status: CREATED, timestamp: 2024-02-08T07:48:35.252449810Z, by: Richa Deo”,
         “startTime”: “2024-02-08T08:00:00Z”,
         “endTime”: “2024-02-08T09:30:00Z”
         }
         ]
      }
   }

Where applicable, various embodiments provided by the present disclosure may be implemented using hardware, software, or combinations of hardware and software. Also, where applicable, the various hardware components and/or software components set forth herein may be combined into composite components including software, hardware, and/or both without departing from the spirit of the present disclosure. Where applicable, the various hardware components and/or software components set forth herein may be separated into sub-components including software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

Although illustrative embodiments have been shown and described, a wide range of modifications, changes and substitutions are contemplated in the foregoing disclosure and in some instances, some features of the embodiments may be employed without a corresponding use of other features. One of ordinary skill in the art would recognize many variations, alternatives, and modifications of the foregoing disclosure. Thus, the scope of the present application should be limited only by the following claims, and it is appropriate that the claims be construed broadly and in a manner consistent with the spirit and full scope of the embodiments disclosed herein.

The Abstract at the end of this disclosure is provided to comply with 37 C.F.R. § 1.72(b) to allow a quick determination of the nature of the technical disclosure. It is submitted with the understanding that it will not be used to interpret or limit the scope or meaning of the claims.

What is claimed is:

1. A counter shift trade request management system comprising:
at least one processor and a non-transitory computer readable medium operably coupled thereto, the non-transitory computer readable medium comprising a plurality of instructions stored in association therewith that are accessible to, and executable by, the at least one processor, to perform operations which comprise:
monitoring a shift schedule for a set of agents using parameters affecting staffing needs and shift trade approval criteria, wherein shift trade requests and counter shift trade requests are submitted by an agent through a graphical user interface;
identifying a shift trade request from a source agent;
identifying a set of tradeable shifts for the source agent;
sending the shift trade request and the set of tradeable shifts to a set of target agents, wherein the shift trade request and the set of tradeable shifts are displayed through the graphical user interface;
receiving a counter shift trade request from a target agent from the set of target agents, wherein the counter shift trade request comprises a tradeable shift within the set of tradeable shifts selected by the target agent;
sending the counter shift trade request to the source agent,
wherein the counter shift trade request is displayed through the graphical user interface; and
wherein when the source agent accepts the counter shift trade request, the shift schedule is updated based on the counter shift trade request; and
sending a schedule notification to the source agent and to the target agent regarding the updated shift schedule.

2. The counter shift trade request management system of claim 1, wherein the parameters comprise one or more of unplanned absenteeism, contact volume inflow, shift characteristics, skills needed, understaffing, overstaffing, or any combination thereof.

3. The counter shift trade request management system of claim 1, wherein the parameters are determined by a contact center supervisor or administrator.

4. The counter shift trade request management system of claim 1, wherein the shift trade request from the source agent may be a request to exchange a full shift assigned to the source agent, or a portion of a full shift assigned to the source agent.

5. The counter shift trade request management system of claim 1, wherein the set of tradeable shifts for the source agent are identified using the parameters affecting staffing needs and shift trade approval criteria.

6. The counter shift trade request management system of claim 1, wherein, when a counter shift trade request from a target agent is not received or when the source agent does not accept a counter shift trade request from a target agent, the operations further comprise closing the shift trade request.

7. The counter shift trade request management system of claim 1, wherein the operations further comprise sending the schedule notification to a supervisor of the source agent or of the target agent.

8. A method of facilitating counter shift trade requests, comprising:
monitoring a shift schedule for a set of agents using parameters affecting staffing needs and shift trade approval criteria, wherein shift trade requests and counter shift trade requests are submitted by an agent through a graphical user interface;
identifying a shift trade request from a source agent;
identifying a set of tradeable shifts for the source agent;
sending the shift trade request and the set of tradeable shifts to a set of target agents, wherein the shift trade request and the set of tradeable shifts are displayed through the graphical user interface;
receiving a counter shift trade request from a target agent from the set of target agents, wherein the counter shift trade request comprises a tradeable shift within the set of tradeable shifts selected by the target agent;
sending the counter shift trade request to the source agent;
wherein the counter shift trade request is displayed through the graphical user interface; and
wherein when the source agent accepts the counter shift trade request, the shift schedule is updated based on the counter shift trade request; and
sending a schedule notification to the source agent and to the target agent regarding the updated shift schedule.

9. The method of claim 8, wherein the parameters comprise one or more of unplanned absenteeism, contact volume inflow, shift characteristics, skills needed, understaffing, overstaffing, or any combination thereof.

10. The method of claim 8, wherein the parameters are determined by a contact center supervisor or administrator.

11. The method of claim 8, wherein the shift trade request from the source agent may be a request to exchange a full shift assigned to the source agent, or a portion of a full shift assigned to the source agent.

12. The method of claim 8, wherein the set of tradeable shifts for the source agent are identified using the parameters affecting staffing needs and shift trade approval criteria.

13. The method of claim 8, wherein, when a counter shift trade request from a target agent is not received or when the source agent does not accept a counter shift trade request from a target agent, the operations further comprise closing the shift trade request.

14. The method of claim 8, wherein the operations further comprise sending the schedule notification to a supervisor of the source agent or of the target agent.

15. A non-transitory computer-readable medium having stored thereon computer-readable instructions executable by at least one processor to perform operations which comprise:
monitoring a shift schedule for a set of agents using parameters affecting staffing needs and shift trade approval criteria, wherein shift trade requests and counter shift trade requests are submitted by an agent through a graphical user interface;
identifying a shift trade request from a source agent;
identifying a set of tradeable shifts for the source agent;
sending the shift trade request and the set of tradeable shifts to a set of target agents, wherein the shift trade request and the set of tradeable shifts are displayed through the graphical user interface;
receiving a counter shift trade request from a target agent from the set of target agents, wherein the counter shift trade request comprises a tradeable shift within the set of tradeable shifts selected by the target agent;
sending the counter shift trade request to the source agent,
wherein the counter shift trade request is displayed through the graphical user interface; and
wherein when the source agent accepts the counter shift trade request, the shift schedule is updated based on the counter shift trade request; and
sending a schedule notification to the source agent and to the target agent regarding the updated shift schedule.

16. The non-transitory computer-readable medium of claim 15, wherein the parameters comprise one or more of unplanned absenteeism, contact volume inflow, shift characteristics, skills needed, understaffing, overstaffing, or any combination thereof.

17. The non-transitory computer-readable medium of claim 15, wherein the parameters are determined by a contact center supervisor or administrator.

18. The non-transitory computer-readable medium of claim 15, wherein the shift trade request from the source agent may be a request to exchange a full shift assigned to the source agent, or a portion of a full shift assigned to the source agent.

19. The non-transitory computer-readable medium of claim 15, wherein, when a counter shift trade request from a target agent is not received or when the source agent does not accept a counter shift trade request from a target agent, the operations further comprise closing the shift trade request.

20. The non-transitory computer-readable medium of claim 15, wherein the operations further comprise sending the schedule notification to a supervisor of the source agent or of the target agent.
